(19) United States
(12) Patent Application Publication
(10) Pub. No.: US 2004/0255588 A1
(43) Pub. Date: Dec. 23, 2004

(54) Catalytic preburner and associated methods of operation

(76) Inventors: Kare Lundberg, Gilbert, AZ (US); Stephen R. Thomas, Simpsonville, SC (US); Ralph A. Dalla Betta, Mountain View, CA (US); Jon G. McCarty, Menlo Park, CA (US); David K. Yee, Hayward, CA (US)

Correspondence Address: MORRISON & FOERSTER LLP, 755 PAGE MILL RD, PALO ALTO, CA, 94304-1018, US

(21) Appl. No.: 10/732,601

(22) Filed: Dec. 9, 2003

Related U.S. Application Data
(60) Provisional application No. 60/432,795, filed on Dec. 11, 2002.

(51) Int. Cl. F02C 1/00

(52) U.S. Cl. 60/723

(57) ABSTRACT

A catalytic preburner includes a flame burner, a catalyst, a primary fuel inlet, a secondary fuel inlet, and an air inlet. The flame burner is located in a primary zone of the housing and the catalyst element is disposed downstream of the primary zone. The primary fuel inlet and the air inlet are configured to supply fuel and air to the flame burner. The secondary fuel inlet and the air inlet are configured to supply fuel and air to a secondary zone within the housing located upstream of the catalyst element.

### CROSS REFERENCE TO RELATED APPLICATION

The present application claims benefit of earlier filed provisional patent application, U.S. application Ser. No. 60/432,795, filed on Dec. 11, 2002, and entitled “CATALYTIC PREBURNER,” which is hereby incorporated by reference as if fully set forth herein.

### BACKGROUND OF THE INVENTION

1. Field of the Invention

This invention relates generally to gas turbine engines, and more particularly to catalytic preburners for gas turbine engines and methods for use with combustors as they relate to and are utilized by gas turbine engines.

2. Description of the Related Art

One widely used device for the generation of electricity, power, and heat is the gas turbine engine. A typical gas turbine engine operates by intaking air and pressurizing it using a rotating compressor. The pressurized air is passed through a chamber, or “combustor,” wherein fuel is mixed with the air and burned. The high temperature combustion of the fuel-air mixture expands across a rotating turbine, resulting in a torque created by the turbine. The turbine may then be coupled to an external load to harness the mechanical energy. Gas turbine engines are commonly used for electrical generators, and to power turbo-prop aircraft, pumps, compressors, and other devices that may benefit from rotational shaft power.

In a typical gas turbine engine, the combustion chamber, fuel delivery system, and control system are designed to ensure that the correct proportions of fuel and air are injected and mixed within one or more “combustors.” A combustor is typically a metal container or compartment wherein the fuel and air are mixed and burned. Within each combustor, there is typically a set of localized zones where the peak combustion temperatures are achieved. These peak temperatures commonly reach temperatures in the range of 3,300 degrees Fahrenheit. The high temperatures trigger the formation of nitric oxide and nitrogen dioxide (NO_{X}), which are known pollutants. Typically, to prevent thermal distress or damage to these metallic combustion chambers, a significant amount of the compressor air passes around the outside of the combustors to cool them. The hot combustion gasses are then mixed with this cooling air toward the exit of the combustor. The resulting hot gas yield, which is admitted to the inlet of the turbine, is delivered at a temperature in the range of 2,400° F. at full load for a typical industrial gas turbine. Unfortunately, virtually all of the NO_{X} produced in the peak temperature zones within the combustor is exhausted into the atmosphere.

In an effort to reduce the amount of pollutants generated and released by the combustion of fuel, significant effort has been expended to develop a flameless combustion process useable in gas turbine engines. One such flameless combustion process, for example, uses a catalyst module design that employs a honeycomb-like construction with a large surface area. Catalysts imparted onto the interior surfaces of the honeycomb structure serve to catalyze the chemical reaction of the fuel and air. This allows for “distributed combustion,” in which complete combustion of the fuel and air occurs at relatively low temperatures, and with comparatively low concentrations of fuel. Due to the catalyst construction, the heat produced by the catalytic module occurs over a large zone and occurs very uniformly, eliminating “hot zones” typical in flame combustors thereby reducing NO_{X}.

Catalytic combustors typically include a diffusion flame preburner or a lean-premixed (LPM) flame preburner that is used to preheat the compressor discharge air to a temperature sufficiently high to activate the catalyst. This catalyst activation temperature is commonly referred to as light-off temperature (LOT). The preburner continuously operates over a range of temperature rises throughout the engine's operating cycle to ensure the catalyst is operating above its LOT, and to minimize carbon monoxide (CO) and unburned hydrocarbon (UHC) emissions over the engine's operating range.

A drawback of an LPM flame or diffusion flame preburner, however, is that the LPM flame or diffusion flame preburner generates NO_{X} emissions. In particular, the flame temperature of the LPM flame or diffusion flame preburner in the various stages of operation is sufficiently high to create NO_{X} emissions. Therefore, it is desirable to reduce or eliminate the formation of NO_{X} in the primary stage or flame portion of a preburner.

Further, the combustion efficiency of a typical preburner flame is not always fully predictable. In typical preburners consisting of multiple stages of LPM or diffusion piloted flame combustion, the combustion efficiency of the downstream stages is not always 100%. At times, the combustion efficiency can change very rapidly (within fractions of seconds) within a narrow band of operating conditions. These rapid transitions can induce undesirable combustion instabilities, dynamics, and oscillations in the combustor operation.

### BRIEF SUMMARY OF THE INVENTION

According to a first aspect of the invention, a catalytic preburner includes a housing with a flame burner, a catalyst element, a primary fuel inlet, a secondary fuel inlet, and an air inlet. The flame burner is located in a primary zone of the housing and the catalyst element is disposed downstream of the primary zone. The primary fuel inlet and the air inlet are configured to supply fuel and air to the flame burner. The secondary fuel inlet and the air inlet are configured to supply fuel and air to a secondary zone within the housing located upstream of the catalyst element. According to one example, a first stage of the preburner includes the flame burner, the primary fuel inlet, the secondary fuel inlet, and the air inlet. The second stage includes the catalyst element. In further examples, third, fourth, etc. stages may be included with additional catalyst elements located downstream of the first stage, i.e., flame burner.

In one example, the fuel and air from the primary zone and the fuel and air from the secondary zone mix in a region upstream from the catalyst. In another example, the fuel and air from the primary zone and the fuel and air from the secondary zone are separated upstream of the catalyst. In yet another example, the preburner may further include a dilution zone within the housing located downstream of the catalyst where additional air may be added. The dilution zone may include adjustable air inlets to provide varying amounts of air. Further, in examples that include third, fourth, etc. stages, additional fuel and air may be added at each stage.

According to a second aspect of the present invention, a catalytic combustor system includes a main combustor housing and a catalytic preburner housing disposed such that the outlet gas from the preburner is introduced within the combustor upstream from a main catalyst of the combustor. The catalytic preburner may be substantially as described above with regard to the first aspect of the present invention and the various examples. Further, the preburner housing may be suitably located within or adjacent to the combustor housing.

According to a third aspect of the present invention, a method for operating a combustion system with a catalytic preburner is provided. The method includes the acts of catalytically combusting fuel in a preburner portion of the combustion system, wherein the preburner portion includes a flame burner and a catalyst. The method further includes supplying fuel to the flame burner, and supplying fuel to the catalyst.

According to a fourth aspect of the present invention, a method for operating a system including a catalytic preburner is provided. The method includes operation of a preburner, including a first stage and a second stage. The first stage includes a flame burner located in a primary zone of the preburner, a primary fuel inlet configured to supply fuel to the burner, an air inlet configured to provide air to the burner, a secondary fuel inlet configured to supply fuel to a secondary zone of the preburner, and an air inlet configured to provide air to the secondary zone. The second stage includes a catalytic element. The method includes in a first phase of operation supplying primary fuel and air to the flame burner, igniting the flame burner, and supplying a secondary fuel and air to the secondary zone of the preburner. The exemplary method may further include a second phase of operation that includes extinguishing the flame burner after the catalyst temperature has risen above light-off temperature. In one example, the primary fuel to the flame burner may be re-introduced after the flame burner has been extinguished.

Additionally, various exemplary methods of operating and controlling a catalytic preburner based on, for example, fuel and/or air supply versus turbine speed and/or engine load schedules are provided.

The present invention is better understood upon consideration of the detailed description below in conjunction with the accompanying drawings and examples.

### BRIEF DESCRIPTION OF THE DRAWINGS

FIG. 1 illustrates exemplary catalyst light-off and extinguish temperature curves;

FIG. 2 illustrates a schematic representation of an exemplary gas turbine engine system including a catalytic combustor and catalytic preburner;

FIG. 3 illustrates a cross-sectional view of an exemplary gas turbine engine system including a catalytic combustor with a catalytic preburner;

FIG. 4 illustrates a cross-sectional view of an exemplary catalytic preburner; and

FIG. 5 illustrates a graph of exemplary catalytic preburner temperatures during turbine acceleration and engine loading.

### DETAILED DESCRIPTION OF THE INVENTION

The present invention provides a catalytic preburner and associated methods of operation. The following description is presented to enable any person or ordinary skill in the art to make and use the invention. Descriptions of specific applications are provided only as examples. Various modifications to the preferred embodiments will be readily apparent to those skilled in the art, and the general principles defined herein may be applied to other embodiments and applications without departing from the spirit and scope of the invention. Thus, the present invention is not intended to be limited to the examples shown, but is to be accorded the widest scope consistent with the principles and features disclosed herein.

Broadly speaking, an exemplary catalytic preburner includes a flame burner and a catalyst (sometimes referred to herein as a secondary catalyst in relation to a main stage catalyst). The flame burner is used in a first stage of the preburner and the catalyst is used in the second stage. The flame burner is used to heat the secondary catalyst burner to a temperature sufficient to support catalytic combustion in the second stage. Once the temperature has reached a sufficient level, the flame burner may be extinguished. The preburner may further include third, fourth, etc. stages of catalysts as well as the introduction of further fuel and/or air.

The first stage of the preburner may further be divided into a primary zone and secondary zone. The primary zone includes the flame burner; the secondary zone includes a region where additional fuel and air may be added upstream of the second stage, including the secondary catalyst. In some examples, the fuel and gas from the primary zone mixes with the additional fuel and air in the secondary zone upstream of the secondary catalyst. Because the flame burner may be extinguished after the catalyst in the second stage has begun catalytic combustion, formation of NO_{X} may be reduced or eliminated in the preburner without negatively impacting combustion in the catalytic second stage.

Typical preburners as used in today's combustors, in contrast, consist of multiple stages of an LPM flame, diffusion flame, or the like. In the first stage, a flame burner is operated at very high temperatures that cause the formation of NO_{X}. The high temperature of the flame burner supports combustion in the second stage. The combined heat from the first stage and second stages support combustion in the third stage. This pattern of combustion support from the upstream heat continues for any additional stages of the preburner. NO_{X} formation is generally limited to the first stage where the flame temperature is generally the highest. Second stage, third stage, etc. temperatures are cooler because the combined heat from the prior stages supports combustion with a cooler temperature flame; NO_{X} is not formed because of the lower temperature in these stages. Therefore, to eliminate NO_{X} in a typical preburner with multiple stages of combustion, it would be desirable to extinguish the flame burner in the first stage. However, in doing so, the downstream flame burners, i.e., second stage, third stage, and so on, often become unstable and flame out.

Therefore, according to one example of the invention, a catalyst replaces the second stage flame burner of a typical preburner and extinguishes the flame burner in the first stage after the secondary catalyst is sufficiently heated to support catalytic combustion. The first stage includes, for example, an LPM flame or diffusion flame burner followed by a catalytic element in the second stage, third stage, and so on. The catalytic preburner may eliminate or diminish NO_{X} formation without negatively impacting combustion in the catalytic second stage, third stage etc. because the first stage flame burner may be extinguished after the second stage catalyst burner has reached a temperature sufficiently high to support catalytic combustion (commonly referred to as a “light-off” temperature). Further, high combustion efficiency is not required in the preburner's first stage flame burner because any uncombusted fuel will subsequently be combusted by the secondary catalyst. Once the second stage, third stage, etc. catalytic stages have achieved a sufficiently high temperature to support catalytic combustion, their combustion efficiency remains unchanged resulting in very predictable rises in their temperature.

Various aspects of the invention will now be described, including an exemplary catalyst used in a flame burner, a combustion system including the catalytic preburner, and various methods of controlling and operating a combustion system including a catalytic preburner.

I. Preburner Catalyst

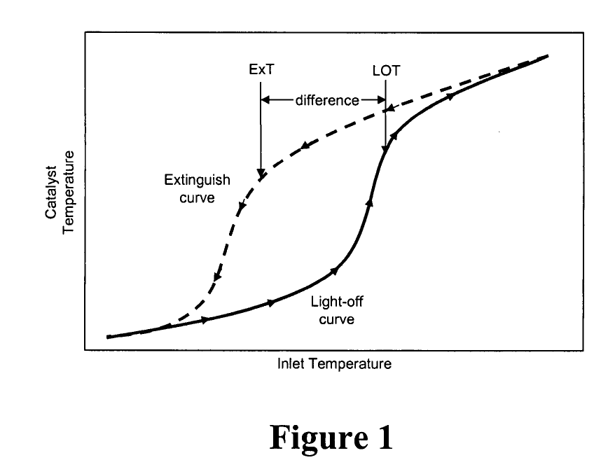

In one example, the characteristics of an exemplary catalyst for use with a catalytic preburner are such that the catalyst light-off temperature (LOT) is minimized and the difference between the catalyst LOT and extinguish temperature (ExT) is maximized. Increasing or maximizing the difference between catalyst LOT and EXT ensures that the catalyst will stay lit during any fluctuations in the temperature after the initial preburner flame is extinguished. The relationship between catalyst LOT and ExT is illustrated graphically in FIG. 1. As seen in FIG. 1, the catalyst LOT curve and the ExT curve generally rise from left to right as the inlet temperature increases. As seen, the ExT curve is off-set with respect to the LOT curve such the catalyst LOT curve occurs at a higher inlet temperature than the catalyst ExT curve for most catalyst temperatures. By decreasing or reducing the LOT while simultaneously increasing or maximizing this off-set or difference between the catalyst LOT curve and ExT curve the inlet temperature may fall farther below the LOT curve before the catalyst will be extinguished. This provides increased operational flexibility for a catalytic preburner.

The difference between the catalyst LOT and ExT curves may be increased, for example, by increasing the reaction between the fuel and the catalyst materials without changing the heat transfer rate. For example, coating both sides of a monolithic substrate with an active catalyst material increases the kinetic reaction, but would have minimal impact on the heat transfer rate and thus increases the difference between the catalyst LOT and the ExT. An exemplary monolithic substrate may include a unitary or bonded metallic or ceramic structure made up of a multitude of longitudinally disposed channels for passage of air and fuel. Other exemplary catalyst structures may be fabricated from metallic or ceramic substrates in the form of honeycombs, spiral rolls of corrugated sheet, columnar (or “handful of straws”), or other configurations having longitudinal channels or passageways permitting high gas space velocities with minimal pressure drops across the catalyst structure.

Exemplary catalyst materials generally include metals of the platinum group such as Pt, Pd, and Rh because of their relative stability at high temperatures and reactivity with hydrocarbon fuels. For example, catalyst materials and structures described in the following U.S. Patent applications may be used: U.S. Pat. No. 5,258,349 entitled, “Graded Palladium-Containing Partial Combustion Catalyst,” U.S. Pat. No. 5,248,251 entitled “Graded Palladium-Containing Partial Combustion Catalyst and a Process for using it,” U.S. Pat. Nos. 5,259,754 and 5,405,260 both entitled, “Partial Combustion Catalyst of Palladium on a Zirconia Support and a Process for using it,” U.S. Pat. No. 5,232,357 entitled, “Multistage Process for Combusting Fuel Mixtures using Oxide Catalysts in the Hot Stage,” and U.S. Pat. No. 5,250,489 entitled, “Catalyst Structure Having Integral Heat Exchange,” all of which are incorporated by reference in their entirety as if fully set forth herein

Further, exposing the catalyst to a rich fuel-to-air ratio, exposing the catalyst to a high activation energy fuel such as methane or the like, and minimizing mass transfer limitations through cell geometry, corrugation designs wash-coat structure, and the like may further increase the difference between the LOT and the ExT. For instance, an exemplary catalyst design may include coating both sides of a corrugated substrate including large straight channel cells.

II. Combustion System and Catalytic Preburner

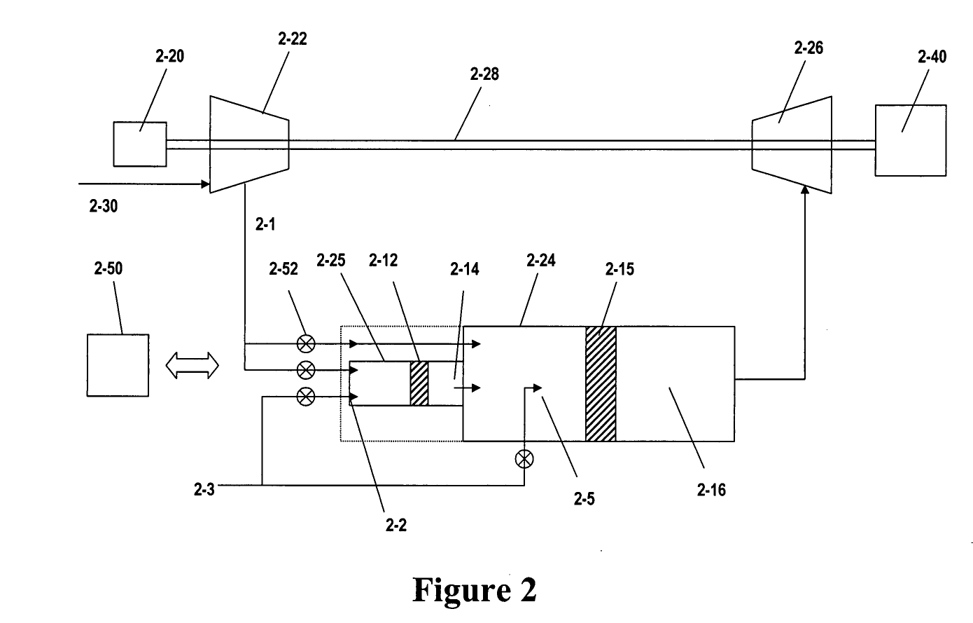

FIG. 2 illustrates an exemplary catalytic preburner and combustion gas turbine engine. The combustion gas turbine engine generally includes a compressor 2-22, a catalytic combustion chamber 2-24, and a turbine 2-26. Air 2-30 is supplied to compressor 2-22, which produces compressor discharge air 2-1 having a predetermined higher pressure and higher temperature. The compressor discharge air 2-1 is directed to the catalytic combustion chamber 2-24. The compressor discharge air 2-1 may pass through by-passes, control valves 2-52, different effective areas, and the like to be distributed within catalytic combustion chamber 2-24 at desired locations. Further, a pre-heating section (not shown) may be included to deliver the compressor discharge air 2-1 at a desired temperature.

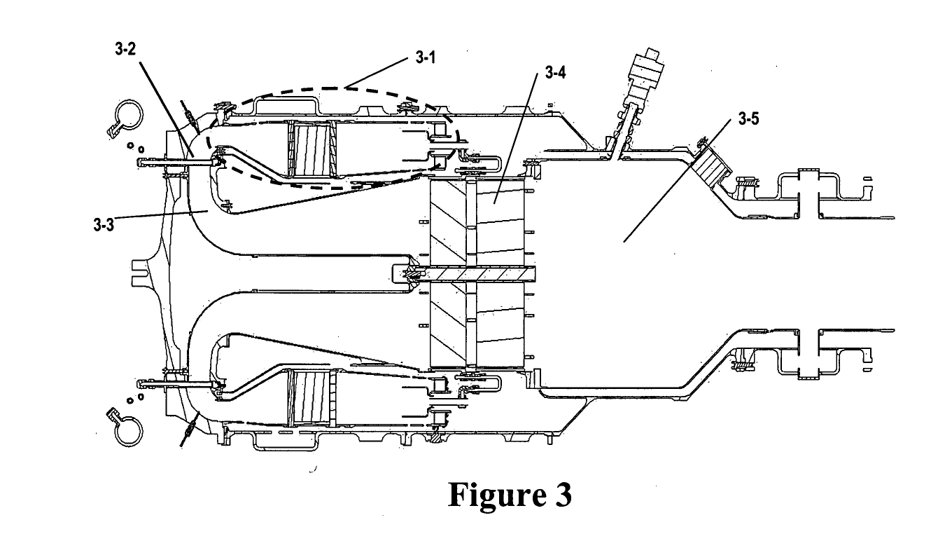

A fraction of the compressor discharge air 2-1 flows to the catalytic preburner housing 2-25. Catalytic preburner 2-25 may be located adjacent to or within combustor chamber 2-24 (as indicated by the dotted lines). For example, the catalytic preburner 2-25 will generally be located within combustor chamber 2-24, however, the catalytic preburner 2-25 may be configured in-line with the combustor chamber 2-24 and main stage catalyst 2-15 or annularly around or exterior to the main stage catalyst 2-15 (as shown in FIG. 3). Thus, the location and orientation of catalytic preburner 2-25 may be varied depending on the particular application and design.

The compressor discharge air 2-1 may be supplied directly from compressor 2-22. The compressor discharge air 2-1 mixes with the fuel 2-3 at burner 2-2 within preburner 2-25. The fuel 2-3 and a fraction of compressor discharge air 2-1 bum within preburner 2-25. A portion of the preburner 2-25 located upstream of the catalyst 2-12 may further be divided into primary and secondary zones (not shown) located upstream of catalyst 2-12. The primary and secondary zones may receive separate supplies of fuel 2-3 and compressor discharge air 2-1. In some examples the fuel 2-3 and compressor discharge air 2-1 mixture mixes with additional fuel and/or air in a secondary zone upstream of catalyst 2-12. In other examples, a primary zone and secondary zone may be physically separated upstream of catalyst 2-12 such that primary and secondary fuel and air do not mix prior to catalyst 2-12.

The hot fuel-air gas mixture then passes over catalyst 2-12 located downstream of the flame burner 2-2. Additional compressor discharge air 2-1 and/or fuel 2-3 may be included prior to passing over the catalyst 2-12. The fuel-air mixture reacts on the catalyst surface of catalyst 2-12, such that the fuel-air mixture exiting the catalyst 2-12 is higher in temperature than the fuel-air mixture entering the catalyst 2-12 within catalytic preburner 2-25. The fuel-air mixture exiting the catalyst 2-12 may mix with a fraction of the compressor discharge air 2-1 in the catalyst dilution region 2-14. Varying amounts of compressor discharge air 2-1 may be mixed in the catalyst dilution region 2-14. For example, to achieve the highest temperature entering the main stage catalyst 2-15 no compressor discharge air 2-1 should be added. The amount of discharge air 2-1 may also be adjusted or held constant using, for example, adjustable or fixed orifices to effect a varying or fixed temperature reduction of the hot fuel-air gas mixture prior to entering the main stage fuel mixer. The amount of discharge compressor air 2-1 may also be varied with inlet guide vanes or the like. It should be recognized that various other schemes and devices may be employed to vary the temperature of the fuel-air gas mixture, e.g., by staging the discharged compressor air 2-1 or varying the amount of fuel 2-3.

The fuel-air gas mixture then mixes with the main stage fuel supplied from main stage fuel injector 2-5 and additional discharged compressor air 2- 1. Additional discharged compressor air 2-1 may be supplied directly to combustor 2-24 or pass through preburner 2-25, for example, through a region adjacent flame burner 2-2 and catalyst 2-12, i.e., within the dotted line of FIG. 2. Main stage fuel injector 2-5 may include various known fuel injection systems such as a spray nozzle, fuel orifice and vane swirler, or the like. The fuel may include a suitable hydrocarbon fuel or the like.

The fuel-air mixture then passes across the main stage catalyst 2-15 and reacts together in the presence of the catalyst material included in catalyst 2-15. The fuel-air mixture bums downstream of the catalyst 2-15 in the burnout zone 2-16. The thermal output of the combustor 2-24 is greater than the thermal output of the preburner 2-25. The resulting higher temperature and pressure gas mixture produced by the combustion is passed to the turbine 2-26 where the energy of this gas is converted into rotational energy of the turbine shaft 2-28. The rotational energy of the turbine shaft 2-28 may be used to drive the compressor 2-22 as well as a load 2-40, for example, an output device such as a generator or the like. A starter motor 2-20 may also be connected to shaft 2-28 to start the gas turbine, for example, to supply the initial compressor discharge air 2-1 from air 2-30 or provide an initial acceleration of the turbine shaft 2-28.

Further, the catalytic combustion system may include a control system 2-50 that is in communication with the system. Control system 2-50 operates generally to monitor and control various aspects of the catalytic combustion system and gas turbine. For example, control system 2-50 may measure the rotational speed of the shaft 2-28, the load 2-40 upon the engine, and the like. Control system 2-50 further operates to control the various valves 2-52 that control the amount of fuel and air delivered to the catalytic combustor 2-24 and catalytic preburner 2-25, as well as the amount of compressor discharge air 2-1 to enter the dilution region 2-14. This allows the control system 2-50 to coordinate the stages of the preburner 2-25, deliver fuel and air based on the temperature, engine speed, and/or engine load, adjust for catalyst aging, and the like.

FIG. 3 illustrates a cross-section view of an exemplary catalytic preburner included within a catalytic combustor. The exemplary catalytic combustor includes an annular shaped catalytic preburner 3-1. The annular design of catalytic preburner 3-1 is for illustrative purposes only and it should be recognized that other designs, for example, that fit the existing space and orientation of current diffusion or LPM preburner designs are possible. Further, the catalytic preburner 3-1 may be positioned exterior to the housing of the main combustor with the outlet coupled to the combustor.

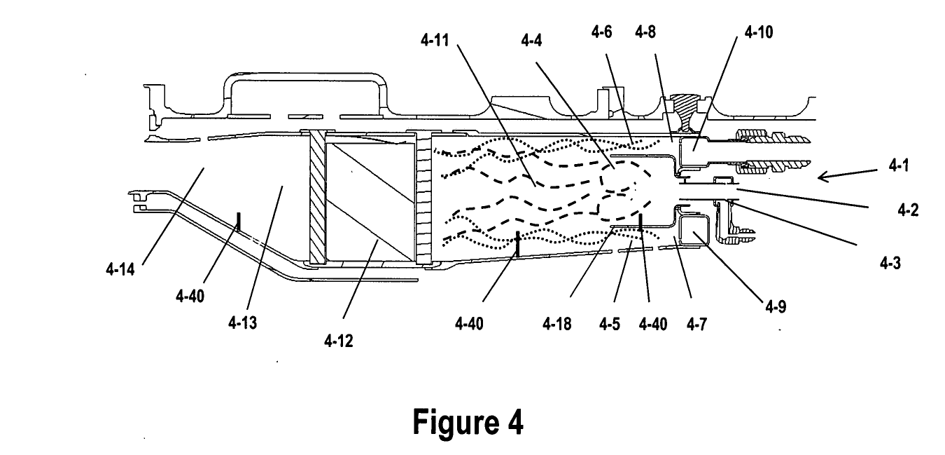

The preburner produces a high temperature gas that may include residual fuel uniformly mixed therein that exits the secondary catalytic preburner 3-1 and passes through the main stage fuel injector 3-2. Characteristics of the secondary catalytic preburner 3-1, and various methods of operation are described in greater detail below in reference to FIG. 4.

The main stage fuel injector 3-2 may inject a suitable fuel such as natural gas, methane, or the like. The mixture of vitiated air and any unreacted fuel from the catalytic preburner 3-1 and the main stage fuel from the main stage fuel injector 3-2 are mixed in region 3-3 before passing across the main stage catalyst 3-4. The main stage catalyst 3-4 may consist of any suitable catalyst material. As the fuel and air combust in the presence of the main stage catalyst 3-4 the gas increases in temperature and expands through the post catalyst homogenous combustion burnout zone 3-5.

FIG. 4 illustrates a more detailed view of the exemplary catalytic preburner 3-1 depicted in FIG. 3. In particular, components of the exemplary catalytic preburner 3-1 are illustrated and described with regard to the general operation of a catalytic preburner. More specific methods of operation will be described below under the heading “Methods of Operating a Catalytic Preburner.”

A fraction of the compressor discharge air 4-1 flows into the flame burner 4-2 and mixes with the primary fuel 4-3 of the flame burner 4-2. The flame burner 4-2 may be any suitable burner, for example, a diffusion burner, LPM burner, and the like. In the first stage of the preburner, the primary zone fuel-air mixture burns in the primary combustion zone 4-4 located generally within structure 4-18.

A fraction of the compressor discharge air 4-1 may also flow into secondary dilution zones 4-5 and 4-6 where compressor discharge air 4-1 mixes with secondary fuel 4-7 and 4-8 injected through secondary fuel manifolds 4-9 and 4-10. In this particular example, the secondary fuel is added in two annular regions inside and outside of the primary combustion zone 4-4; however, other suitable designs may be used as will be appreciated by those skilled in the art. In this example, the secondary fuel 4-7 and 4-8 mixes with the hot combustion gases (shown by small and large dotted lines respectively) exiting the primary combustion zone 4-4 in the mixing region 4-11 located downstream of the primary combustion zone 44 and upstream of the secondary catalyst 4-12. The secondary fuel does not burn when mixed with the hot combustion gases exiting the primary combustion zone 4-4 prior to entering the secondary catalyst 4-12. Rather, a high temperature fuel-air gas mixture is created in the mixing region 4-11.

The hot fuel-air gas mixture then passes over the secondary catalyst 4-12. The fuel-air mixture reacts on the catalyst 4-12 surface, such that the fuel-air mixture exiting the secondary catalyst 4-12 is higher in temperature than the fuel-air mixture entering the secondary catalyst 4-12. The fuel-air mixture exiting the catalyst 4-12 may mix with a fraction of the compressor discharge air 4-1 in the catalyst dilution region 4-14. Varying amounts of relatively cooler compressor discharge air 4-1 may be mixed in the catalyst dilution region 4-14. For example, to achieve the highest temperature entering the main stage fuel mixer from the preburner no compressor discharge air 4-1 should be added. The amount of discharge air 4-1 may also be held constant using, for example, fixed orifices to effect a fixed or known temperature reduction of the hot fuel-air gas mixture prior to entering the main stage fuel mixer. Additionally, adjustable orifice sizes may be used to change the amount of compressor discharge air 4-1 added and thus the amount of reduction in temperature prior to the fuel-air gas mixture entering the main stage fuel mixer. It should be recognized that various other schemes and devices may be employed to vary the temperature of the fuel-air gas mixture.

When the first stage of the preburner has completed preheating the second stage to a sufficient temperature for light-off and the compressor discharge air temperature is above the extinguishing temperature of the catalyst 4-12, the flame burner 4-2 may be extinguished or turned off. In one exemplary method of operation, the preburner flame is turned off momentarily by stopping the supply of primary fuel 4-3 to extinguish the flame. Once the flame is extinguished, the primary fuel 4-3 supply may then be re-initiated to supply unburned fuel to the mixing region 4-11 to mix with secondary fuel 4-7 and 4-8 from the secondary zones 4-5 and 4-6.

The exemplary operation of the catalytic preburner described therefore includes using an LPM, diffusion flame burner, or the like in the first stage and catalyst 4-12 in the second stage. The first stage, i.e., with flame burner 4-2, is used to assist in accelerating the turbine and preheating the second stage, i.e., with catalyst 4-12. High combustion efficiency is not required in the preburner's first stage burner because any uncombusted fuel will eventually be combusted when the second stage, i.e., catalyst 4-12, or main stage, i.e., catalyst 3-4, is heated to its light-off temperature.

The catalytic preburner design may also include a catalytic third, fourth, etc. stage. Between these additional catalyst stages there may exist additional fuel injection and/or dilution air injection. Additional fuel injection and dilution air injection may be independently controlled to compensate for catalyst aging and further as an alternative approach to expanding the preburner's turndown range. The temperature at various points or regions within the catalyst preburner may be monitored by temperature sensors 4-40 or the like. Temperature sensors 4-40 may include thermocouples, optical sensors, and the like. Further, the catalytic preburner may include more or fewer temperature sensors 4-40 than shown.

The catalytic preburner may further include features such as distinctly separate primary and secondary zones that do not allow the primary gases to mix with the secondary gases prior to entering the catalyst. For example, structure 4-18 may be extended laterally to catalyst 4-12 such that primary zone 4-4 and secondary zones 4-5 and 4-6 extend to catalyst 4-12. In such an instance, primary fuel 4-3 and secondary fuel 4-7 and 4-8 would not mix, and mixing region 4-11 would be absent. It should be recognized that various methods and configurations may be used to separate primary zone 4-4 and secondary zones 4-5 and 4-6, as well as adjustable configurations that allow control over the size and presence or absence of mixing region 4-11.

Regardless of the primary zone 4-4 and secondary zone 4-5 and 4-6 configuration, the fuel-to-air uniformity entering the catalyst 4-12 from the primary and secondary zones fuel injection is desirably about ±30% and more desirably about ±15%. The mean fuel-to-air ratio entering the catalyst 4-12 is preferably lean and corresponds to an adiabatic combustion temperature up to about 1000° C., and more preferably less than about 850° C. Alternatively, a relatively rich fuel-air mixture including sufficient oxygen and fuel to react on the catalyst may be used, and preferably a mixture with a near minimum of oxygen and fuel to react on the catalyst, for example, where oxygen is not the limiting component.

III. Methods of Operating a Catalytic Preburner

According to one aspect of the invention a catalytic preburner operates by using a flame preburner in the first stage. The flame burner may be extinguished when the catalyst in the second stage has reached a sufficient temperature to sustain catalytic combustion. For example, an exemplary method of operating the catalytic preburner depicted in FIGS. 3 and 4, includes a first phase of operation wherein the flame burner 4-3 is ignited to heat catalyst 4-12 in the second stage. In a second phase of operation, subsequent to catalyst 4-12 achieving a temperature to sustain catalytic combustion, the flame of flame burner 4-2 is extinguished thereby leaving catalyst 4-12 to preheat the temperature of discharged compressor air 4-1 above the light-off temperature of a main stage catalyst 3-4. The catalytic preburner eliminates or reduces the formation of NO_{X} in the preburner 3-1. In applications where the temperature of the bum-out zone is sufficiently low to prevent the formation of NO_{X} the combustion system with the catalytic preburner may be operated to generate zero NO_{X} emissions.

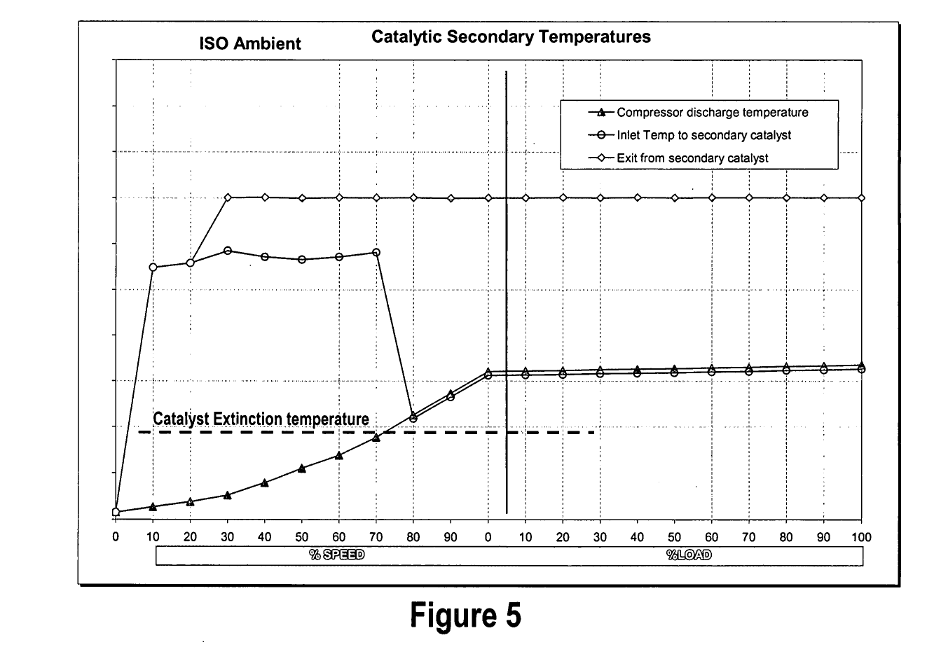

FIG. 5 illustrates a graph of catalytic preburner temperatures during acceleration and loading of a turbine in an exemplary system. In the example depicted in FIG. 5, the primary zone burner is ignited at a turbine speed between 0 and 10%. In some examples, a motor may be employed to provide the turbine with an initial speed prior to igniting the primary zone burner. The primary zone burner raises the temperature entering the secondary catalyst above the compressor discharge temperature (CDT) and above the catalyst light-off temperature (i.e., the catalyst has achieved light-off temperature).

At a low turbine speed, for example, located in FIG. 5 between 20 to 30% speed, secondary fuel is introduced and reacts on the secondary catalyst within the catalytic preburner. The temperature exiting the secondary catalyst thereafter rises above the temperature entering the secondary catalyst.

As the turbine continues to accelerate, CDT eventually rises above the secondary catalyst extinction temperature. At this point, fuel to the primary burner is momentarily turned off to flame-out, i.e., extinguish the flame combustion in the primary combustion zone. Flame-out may be confirmed by a thermocouple measurement, flame detector instrument, and the like. Upon confirmation of flame-out, the primary fuel may be re-introduced to the system. The uncombusted fuel exiting the primary zone reacts on the catalyst to maintain the same catalyst exit temperature achieved prior to the primary zone flame-out. The temperature entering the secondary catalyst is now approximately equal to CDT.

### EXAMPLE I

### Fuel flow schedules vs. speed/load

In one exemplary method the fuel flow may be controlled and delivered to the preburner based on the turbine speed or a measurement of the engine load. During the acceleration sequence, as described with respect to FIG. 5, the fuel delivered to each stage of the preburner may be based, at least in part, on a schedule of mass fuel flow versus the turbine speed. For example, during an acceleration sequence, the fuel flow may be increased. Once the turbine has achieved approximately full speed the fuel flow may then be based upon a fuel flow schedule based, at least in part, on one or more fundamental measurements of the engine load.

A fuel flow schedule may include an equation, program, table, or the like which includes the desired fuel flow to different stages of the preburner based on different variables of the system. In this instance, the fuel flow is initially varied, at least in part, on the speed of the turbine during the acceleration sequence. The fuel flow may also be varied, at least in part, on the engine load applied such that the fuel flow is increased as the engine load is increased, for example.

Exemplary fuel flow schedules are described in U.S. Pat. No. 6,095,793 entitled, “Dynamic Control System and Method for Catalytic Combustion Process and Gas Turbine Engine Utilizing Same,” and U.S. patent application Ser. No. 10/071,749 entitled, “Design and Control Strategy for Catalytic Combustion System with a Wide Operation Range,” both of which are incorporated herein by reference in their entirety.

### EXAMPLE II

### Fuel-to-air ratio schedules vs. speed/load

According to another exemplary method the fuel flow may be controlled and delivered to the preburner at each stage based, at least in part, on a fuel-to-air ratio versus turbine speed or engine load. In one example, the control system may use a relationship, e.g., an equation or the like, to determine air flow versus turbine speed or engine load and an accurate measurement of the fuel flow. Alternatively, the fuel-to-air ratio could be measured immediately upstream of the secondary catalyst. A closed-loop feedback control may be used based on the fuel-to-air measurements to meet the fuel-to-air ratio schedule.

### EXAMPLE III

### Temperature schedules vs. speed/load

According to another exemplary method the temperature of each stage of the preburner may be monitored and controlled based, at least in part, on the primary and secondary zone temperature versus turbine speed or engine load. Each stage of the preburner can be instrumented with thermocouples 4-40 (see FIG. 4) or the like to determine the temperature in the primary and secondary zones. A closed-loop control of the outlet temperature of each stage based on a schedule of primary and secondary zone temperature versus speed or load may then be used.

### EXAMPLE IV

### Primary fuel flow schedules vs. speed/load and secondary outlet temperature schedule vs. speed/load

According to another exemplary method the fuel flow to the primary zone may be based on a schedule of mass flow versus turbine speed or engine load. The catalytic stage of the preburner can be fueled as needed by using a closed loop control to achieve a secondary outlet temperature based on a schedule of secondary zone temperature versus turbine speed/load.

In addition to achieving zero NO_{X} emissions, it is also desirable to operate the catalytic preburner to compensate for catalyst aging. As the secondary catalyst in the preburner and/or the main stage catalyst in the combustor ages over time the exit temperature of the catalyst decreases. Therefore, according to another aspect, exemplary methods of operating a catalytic preburner combine the zero or reduced NO_{X} performance with strategies to compensating for catalyst aging in the preburner and/or main catalyst of the combustor.

The various methods, Examples I-IV, may further include controllably varying the amount of the dilution air in order to vary the preburner exit gas temperature. Specifically, as the catalyst ages and produces a lower catalyst exit temperature the amount of dilution air may be decreased thereby maintaining an approximately constant preburner outlet temperature. The amount of dilution air may be controlled and varied by varying the geometry of dilution air inlets or the like. Examples I and II do not directly compensate for the aging of the catalytic flame burner, however, the addition of varying the geometry of the dilution air allows for such compensation by reducing the amount of dilution air as the catalyst ages. The reduction in dilution air may be accomplished by bypassing air around the combustor and reintroducing it downstream of the burnout zone. Alternatively, it may be accomplished by bleeding off air to atmosphere.

Examples III and IV may compensate for catalytic secondary stage aging by reducing the amount of dilution air as the catalyst exit temperature decreases with age. Further, by also varying the geometry of the dilution air of the preburner, Examples III and IV have the added advantage of independently controlling the preburner exit temperature and the catalytic secondary outlet temperature.

The exemplary methods may also be used to compensate for catalyst aging of the main stage catalyst. Methods for controlling the main stage catalyst aging include controlling the preburner exit temperature and/or the compressor discharge air bypass to compensate for main stage catalyst aging. Examples III and IV, with or without varying the dilution geometry, may be used for controlling preburner exit temperature that may be used to compensate for main stage catalyst aging.

The above detailed description is provided to illustrate exemplary embodiments and is not intended to be limiting. It will be apparent to those skilled in the art that numerous modification and variations within the scope of the present invention are possible. Throughout this description, particular examples have been discussed and how these examples are thought to address certain disadvantages in related art. This discussion is not meant, however, to restrict the various examples to methods and/or systems that actually address or solve the disadvantages. Accordingly, the present invention is defined by the appended claims and should not be limited by the description herein.

1. A catalytic preburner combustor for preheating air to activate a main stage catalyst, comprising:
a flame burner located in a primary zone;
a catalyst disposed downstream from the flame burner;
a primary fuel inlet configured to supply fuel to the flame burner;
an air inlet configured to supply air to the flame burner; and
a secondary fuel inlet configured to supply fuel to a secondary zone, wherein the secondary zone is located upstream of the catalyst.

2. The apparatus of claim 1, further comprising:
a secondary air inlet configured to supply air to the secondary zone.

3. The apparatus of claim 2, wherein the secondary zone is located downstream of the primary zone.

4. The apparatus of claim 2, wherein the primary zone and the secondary zone are configured such that fuel in the primary zone does not mix with fuel in the secondary zone prior to entering the catalyst.

5. The apparatus of claim 2, wherein the primary zone and the secondary zone overlap upstream of the catalyst.

6. The apparatus of claim 1, further comprising a dilution air inlet that supplies air to a region downstream of the catalyst.

7. The apparatus of claim 6, where the air supplied to a region downstream of the catalyst is varied.

8. The apparatus of claim 6, wherein the dilution air inlet size may be varied during operation.

9. A catalytic preburner system, comprising:
a flame burner disposed in a housing;
a catalyst disposed downstream from the flame burner;
a primary fuel inlet configured to supply fuel to the flame burner;
an air inlet configured to supply air to the flame burner; and
a secondary fuel inlet configured to supply fuel to the housing upstream of the catalyst; wherein the outlet of the catalyst is adapted to be coupled to a combustor.

10. The system of claim 9, further including a region located adjacent the flame burner and the catalyst, the region configured to allow additional air to flow around the flame burner and catalyst.

11. A catalytic combustor comprising:
a main catalyst;
a main fuel inlet;
a preburner disposed upstream from said main catalyst, wherein said preburner includes:
a flame burner located in a primary zone of the preburner;
a secondary catalyst disposed downstream from the flame burner;
a primary fuel inlet configured to supply fuel to the flame burner;
an air inlet configured to provide air to the flame burner; and
a secondary fuel inlet configured to supply fuel to a secondary zone of the preburner, wherein the secondary zone is located upstream of the secondary catalyst.

12. The apparatus of claim 11, further comprising:
a secondary air inlet configured to supply air to the secondary zone.

13. The apparatus of claim 12, wherein the secondary zone is located downstream of the primary zone.

14. The apparatus of claim 12, wherein the primary zone and the secondary zone are configured such that fuel in the primary zone does not mix with fuel in the secondary zone prior to entering the secondary catalyst.

15. The apparatus of claim 12, wherein the primary zone and the secondary zone overlap upstream of the catalyst.

16. The apparatus of claim I 1, further comprising:
a dilution air inlet that supplies air to a region downstream of the secondary catalyst.

17. The apparatus of claim 16, where the air supplied to a region downstream of the secondary catalyst is varied.

18. The apparatus of claim 16, wherein the dilution air inlet includes an adjustable orifice size.

19. The apparatus of claim 11, further including a bypass air system.

20. A method for operating a combustion system, comprising the acts of:
catalytically combusting fuel in a preburner portion of the combustion system, wherein the preburner portion includes a flame burner and a catalyst;
supplying primary fuel to the flame burner; and
supplying a secondary fuel to the catalyst.

21. The method of claim 20, wherein the supply of primary fuel to the flame burner is at least momentarily stopped to extinguish the flame burner subsequent to the catalyst reaching a sufficient temperature to support catalytic combustion.

22. The method of claim 21, wherein subsequent to extinguishing the flame burner, the supply of primary fuel is reintroduced.

23. The method of claim 20, wherein the supply of primary fuel and the supply of secondary fuel is varied based on a schedule of a mass of the fuel flow versus a characteristic of at least one of turbine speed and engine load.

24. The method of claim 20, wherein the supply of primary fuel and the supply of secondary fuel is varied based on a schedule of a fuel-to-air ratio versus a characteristic of at least one of turbine speed and engine load.

25. The method of claim 20, wherein the preburner further includes an air inlet upstream from the catalyst, and the method further includes the act of measuring a fuel-to-air ratio upstream of the catalyst and closed-loop controlling to a fuel-to-air ratio schedule versus a characteristic of at least one of turbine speed and engine load.

26. The method of claim 20, wherein the preburner includes a primary zone and a secondary zone located upstream of the catalyst, and further including the act of closed-loop controlling to an outlet temperature of the flame burner and the catalyst based on a schedule of a primary zone temperature and a secondary zone temperature versus a characteristic of at least one of turbine speed and engine load.

27. The method of claim 20, wherein the supply of primary fuel and the supply of secondary fuel is varied to achieve a pre-determined outlet temperature from the preburner based on a schedule of a mass of the fuel flow versus a characteristic of at least one of turbine speed and engine load.

28. The method of claim 20, wherein the preburner further includes an air inlet downstream from the catalyst, and the method further includes the act of variably controlling the flow rate through the air inlet and varying the flow rate in response to temperature measurements.

29. A method for controlling a catalytic combustion system including a catalytic preburner outlet disposed upstream of a main stage catalyst, the preburner comprising:
a first stage including:
a flame burner located in a primary zone of the preburner;
a primary fuel inlet configured to supply fuel to the flame burner;
an air inlet configured to provide air to the flame burner;
a secondary fuel inlet configured to supply fuel to a secondary zone of the preburner; and
a secondary air inlet configured to provide air to the secondary zone of the preburner;
a second stage, positioned downstream from the first stage, including:
a secondary catalyst, wherein the secondary fuel reacts on the secondary catalyst;
wherein a first phase of operation the method includes the acts of:
supplying a primary fuel to the flame burner;
supplying a primary air to the flame burner;
igniting the flame burner;
supplying a secondary fuel to the secondary zone; and
supplying a secondary air to the secondary zone.

30. The method of claim 29, wherein a second phase of operation the method includes the acts of:
extinguishing the flame burner subsequent to the secondary catalyst temperature rising above a temperature sufficient to support catalytic combustion.

31. The method of claim 30, wherein the flame burner is extinguished by turning off the primary fuel supplied to the flame burner.

32. The method of claim 30, wherein the second phase of operation further includes the acts of:
re-introducing the primary fuel to the flame burner after the flame burner has been extinguished.

33. The method of claim 29, wherein the fuel supplied to the first stage and the second stage is based on a schedule of a mass of the fuel flow versus a characteristic of at least one of a turbine speed and an engine load.

34. The method of claim 29, wherein the fuel supplied to the first stage and the second stage is based on a schedule of a fuel-to-air ratio versus a characteristic of at least one of turbine speed and engine load.

35. The method of claim 29, further including the act of measuring a fuel-to-air ratio upstream of the secondary catalyst and controlling to a fuel-to-air ratio schedule versus a characteristic of at least one of a turbine speed and an engine load based on a closed-loop feedback of the fuel-to-air ratio.

36. The method of claim 29, further including the act of controlling an outlet temperature of the first stage and the second stages based on a schedule of a primary zone temperature and a secondary zone temperature versus a characteristic of at least one of turbine speed and engine load.

37. The method of claim 29, wherein the fuel supplied to the first stage and second stage is controlled to achieve a pre-determined outlet temperature from the preburner based on a schedule of a mass of the fuel flow versus a characteristic of a turbine speed or an engine load.

38. The method of claim 29, wherein the preburner further includes an air inlet downstream from the secondary catalyst, and the method further includes the act of variably controlling the flow rate through the air inlet and varying the flow rate in response to temperature measurements.

39. A catalyst element for a catalytic preburner combustor, comprising:
a structure with a catalyst material disposed thereon, wherein the catalyst element is configured to increase a reaction between the catalyst material and fuel.

40. The catalyst of claim 39, wherein the structure includes a corrugated substrate with straight channel cells.

41. The catalyst of claim 40, wherein both sides of the corrugated substrate are coated with the catalyst material.

42. The catalyst of claim 39, wherein the structure includes a monolithic substrate.

43. The catalyst of claim 39, wherein the reaction is increased without substantially changing the heat transfer rate of the catalyst material.

44. The catalyst of claim 39, wherein the light-off temperature of the catalyst material is decreased.

45. The catalyst of claim 39, wherein a difference between a light-off temperature of the catalyst material and an extinguish temperature of the catalyst material is increased.
